(19) United States
(12) Patent Application Publication
(10) Pub. No.: US 2016/0094809 A1
(43) Pub. Date: Mar. 31, 2016

(54) TOURING CAM CONTROL

(71) Applicant: Continental Automotive Systems, Inc., Auburn Hills, MI (US)

(72) Inventors: Jorge Curiel-Lopez, Zapopan (MX); Angel Augusto Escobar-Garcia, Tlaquepaque (MX); Luis Ernesto Quiroz de la Mora, Tlaquepaque (MX)

(73) Assignee: CONTINENTAL AUTOMOTIVE SYSTEMS, INC., Auburn Hills, MI (US)

(21) Appl. No.: 14/502,274

(22) Filed: Sep. 30, 2014

(51) Int. Cl. H04N 7/18; H04N 5/232; G02B 27/01; B60R 11/04

(52) U.S. Cl. CPC H04N 7/181; B60R 11/04; H04N 5/23216; H04N 5/23296; G02B 27/01; B60R 2300/105; B60R 2300/802

(57) ABSTRACT

A video recording system for a moving automotive vehicle is provided. The video recording system includes a camera system for recording front, rear, and lateral views from a moving automotive vehicle. A primary display system is provided which is accessible to the operator of the vehicle. A primary camera control system accessible to the vehicle operator is provided to modify views of the camera system. A secondary display system is provided which is accessible to a passenger of the vehicle. A secondary camera control system is also provided which is accessible to the passenger of the vehicle to modify views of the camera system.

### FIELD OF THE INVENTION

The present invention is related to video recording systems for automotive vehicles.

### BACKGROUND OF THE INVENTION

In the chronicles of photography, it has been known for many vehicle passenger photographers to take still pictures and moving pictures from automotive vehicles. Many photographers have been frustrated when attempting to take pictures of their trips from the inside of the vehicle while the vehicle is moving. Often, such attempts produce pictures which are blurry, unfocused, tilted, or too dark. Additionally, the intended subjects of said pictures may be obscured by obtrusive elements of the vehicle getting in the way or reflected from the vehicle's windscreens or windows. It is desirable to provide a vehicle video recording system which can overcome the above noted prior disadvantages.

### SUMMARY OF THE INVENTION

To make manifest the above noted and other manifold desires, a revelation of the present invention is brought forth. In one of the many preferred embodiments, the present invention brings forth a video recording system for a moving automotive vehicle. The moving automotive vehicle video recording system includes a camera system which can record a front view from the vehicle, a rear view from the vehicle, and lateral side view of the vehicle. The video recording system also includes a primary camera display system accessible to an operator of the vehicle. The vehicle operator can control the cameras through a primary camera control system allowing the vehicle operator to modify the views of the camera system. A secondary display system is also provided which is accessible to a passenger or passengers of the vehicle. Additionally, a secondary camera control is accessible to a passenger or passengers of the vehicle to control the camera system. The current inventive video recording system allows an operator of the vehicle or a passenger of the vehicle to make still or moving video recordings with far higher clarity than that provided typically by hand held cameras operated from inside of the vehicle while the vehicle is moving.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic view of a camera utilized in the video recording system for a moving automotive vehicle according to the present invention illustrating the range of movements of the camera;

FIG. 2 is a side elevational view of a vehicle utilizing the video recording system for a moving automotive vehicle according to the present invention;

FIG. 3 is a partial side perspective view of the automotive vehicle shown in FIG. 2;

FIG. 4 is a rear elevational view of the vehicle shown in FIGS. 2 and 3;

FIG. 5 is an enlargement of a passenger display of a video recording system for a moving automotive vehicle according to the present invention; and

FIG. 6 is an interior view of an automobile with a video recording system for a moving automotive vehicle according to the present invention.

### DETAILED DESCRIPTION OF THE PREFERRED EMBODIMENTS

The following description of the preferred embodiment(s) is merely exemplary in nature and is in no way intended to limit the invention, its application, or uses.

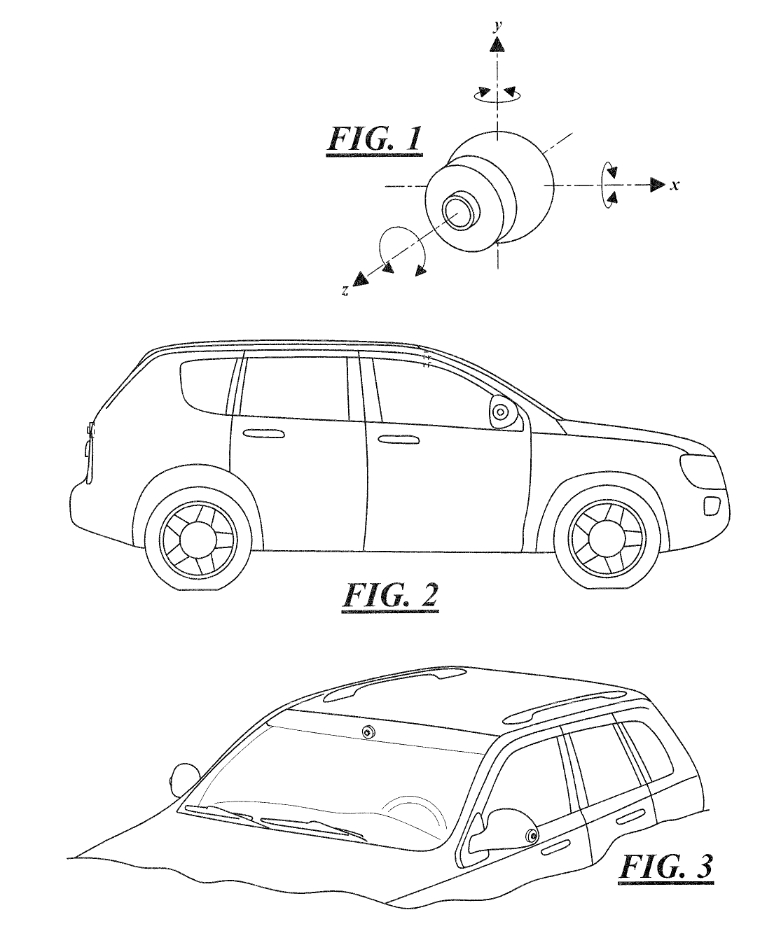

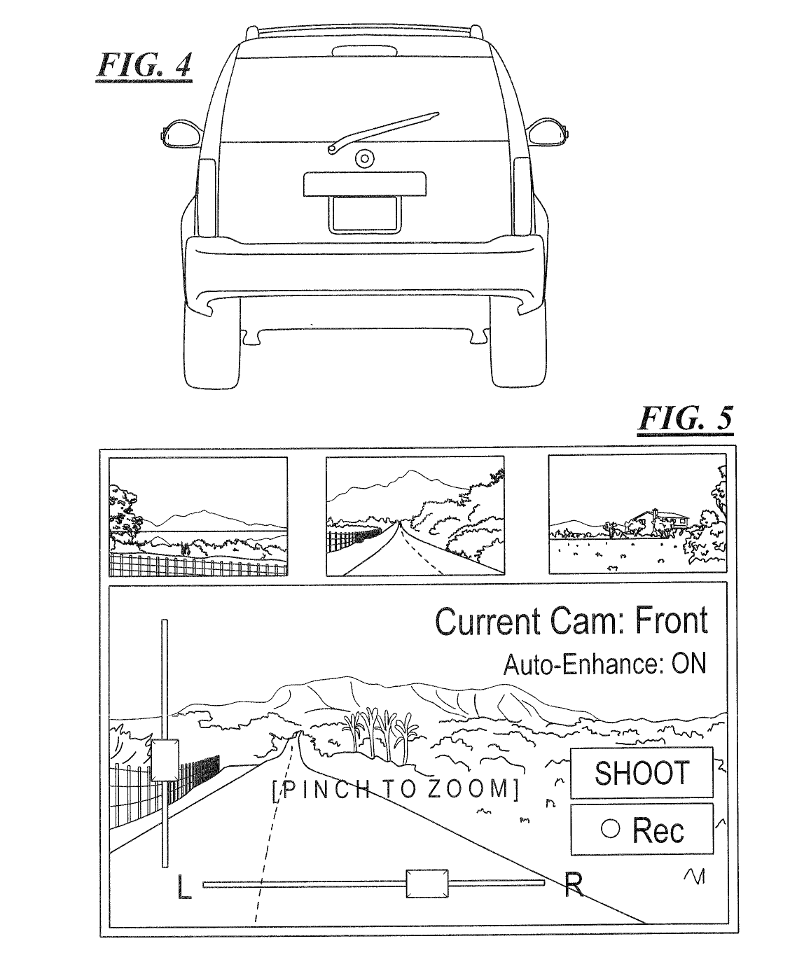

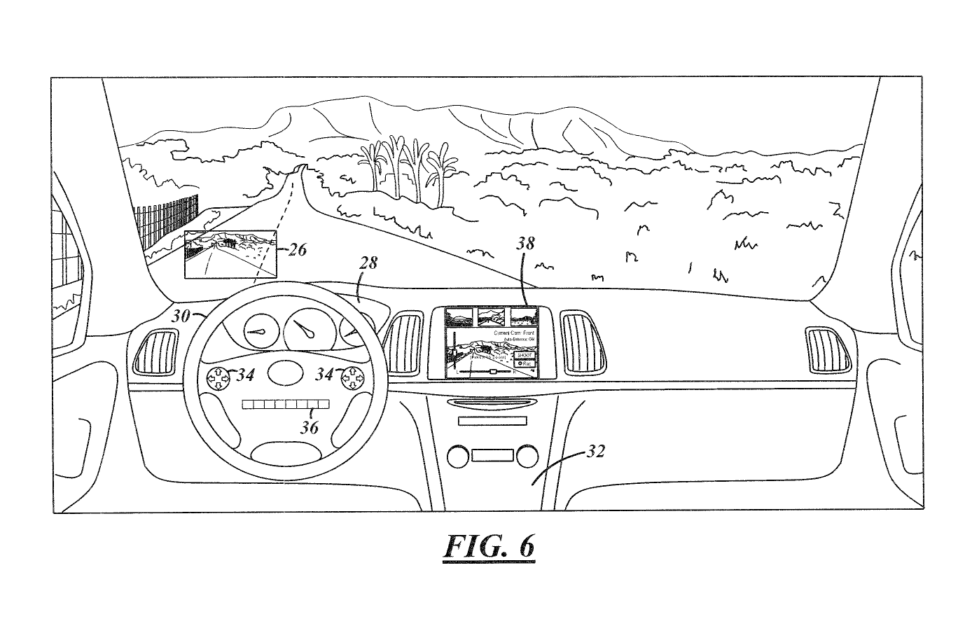

Referring to FIGS. 1-6, a video recording system 7 for a moving automotive vehicle 10 is provided. The video recording system 7 preferably will have four or more cameras 12. The cameras 12 preferably will have the ability to focus in and out along the three major axis X, Y, Z and will also have the ability to tilt its receptive screen along the three major axis X, Y, Z. Two of the cameras may be placed upon the driver side rearview mirror 14 and on the passenger side rearview mirror 16. Placement of the cameras 12 on the rear view mirrors 14, 16 allows the views of the cameras 12 to be virtually totally unobstructed for the lateral views for the video recording system 7. For the front view, a front view camera 18 is provided. Typically, the front view camera 18 will be underneath and protected by the front windshield 20. For the rear view, there is provided a rearview camera 22. The rearview camera 22 is connected on the rear tailgate door 24. The rear camera 22 can also be utilized as a rear vision aid or as a parking aid camera. In another embodiment (not shown) the camera system may be a single camera placed high on a pole or antenna. Such a camera will require multi-axial capabilities.

The views from the camera system are delivered via hardwire or radio signal to a primary display system 26. The primary display system 26 is accessible to the driver operator of the vehicle 10. The primary display system 26 in most applications will be a heads up display which is projected upon the front windshield 20 of the vehicle. In other embodiments (not shown) the primary display system may be incorporated into the instrument panel 28 or on the steering wheel 30 or a cabin divider 32 separating the driver side seat from the passenger side seat.

The vehicle steering wheel 30 has control buttons 34 and 36 to provide a primary camera control system which is accessible to the vehicle operator. The primary camera control system can modify views of various cameras. Additionally, the primary camera control system can be utilized to modify and control the heads up display of the primary display system. The primary camera control system can show views of the camera system in real time. These real time views can be stored to internal/ external media recording device or can be relayed to a cloud video storage system.

The video recording system 7 also has a secondary display system 38. The secondary display system 38 is accessible to a passenger or passengers of a vehicle. As shown, the secondary display system 38 is on the instrument panel of the vehicle; however, in other embodiments not shown, the secondary display may be placed in the seat backs of the vehicle to allow access to the secondary display or multiple secondary display to the rear seat passengers. As shown in FIG. 5, the secondary display 38 can be configured to provide multiple views of the front 40, rear 42, passenger side lateral view 44, and driver side lateral view 46. The secondary display system 38 can additionally have various touch screen functions such as shoot 48 and record 50 allowing it to provide a secondary camera control system with or without the use of additional control buttons if so desired.

The primary camera control system can be configured so that the primary display system will be exclusively operated, or that the primary display system and the secondary display systems will function simultanously. Optionally, the primary camera control system can also have controls allowing exclusive operation of the secondary display system 38. In like manner, the primary camera control system can be made to have controls for exclusive primary control operation, joint primary camera control operation, and secondary camera control function, or exclusive secondary camera control function if so desired. Additionally, the primary camera control system may have controls to allow simultaneous independent control of different video cameras allowing for independent control of separate cameras by the driver and of the passengers. The primary and secondary camera control systems not only can allow for display of videos in real time and for storage of video data to internal/external media and/or to cloud services, but the control system can allow vehicle operator or passenger to select a camera to take a still picture or to start recording video. Camera movements of pan, tilt, and zoom along the three axis X, Y, Z are available. Other functions are available in the primary and secondary camera control. Among them is timer shoot function wherein there is a countdown until the picture is taken; and photo burst, which allows a quick succession of pictures to be taken; time lapse shooting of the journey the vehicle is taking. Another function is auto recording of a brief period (the length of brief period is customizable) to restore the vision from a selected camera. Geotagging (synchronizable with a global positioning satellite (GPS)) and other social network capabilities can be incorporated into the camera control systems. An auto tilt feature can be added to adjust the aim of the camera or cameras when the vehicle 10 is on a non-level surface. As shown in FIG. 5, secondary display system can display multiple camera views.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A video recording system for a moving automotive vehicle comprising:
a camera system for recording front, rear, and lateral views from a moving vehicle;
a primary display system accessible to an operator of the vehicle;
a primary camera control system accessible to the vehicle operator to modify views of the camera system;
a secondary display system accessible to a passenger of the vehicle; and
a secondary camera control system accessible to a passenger of the vehicle to modify views of the camera system.

2. A video recording system for a moving automotive vehicle as described in claim 1 wherein said primary camera control system has control buttons located on a steering wheel of the vehicle.

3. A video recording system for a moving automotive vehicle as described in claim 1 wherein said primary display system is a heads-up windshield display system.

4. A video recording system for a moving automotive vehicle as described in claim 1 wherein said secondary display system shows views of said camera system in real time and said videos can be stored by a method taken from a group of methods including internal/external media and/or cloud services.

5. A video recording system for a moving automotive vehicle as described in claim 1 further comprising a switch allowing for exclusive primary display system operation, exclusive secondary display system operation, and combined primary and secondary display system operation.

6. A video recording system for a moving automotive vehicle as described in claim 1 wherein said camera system has a feature taken from the group of features including timer shoot, photo burst, whole trip time lapse, customizable auto recording blast brief period, geotagging, social media compatibility, auto-tilt to adjust the aim of said camera when said vehicle is on non-level surfaces.

7. A video recording system for a moving automotive vehicle as described in claim 1 wherein said secondary display system can display multiple camera views.

8. A video recording system for a moving automotive vehicle as described in claim 1 wherein said secondary display system is a touch screen forming part of said secondary camera control system.

9. A video recording system for a moving automotive vehicle as described in claim 1 wherein still pictures and recorded video can be stored in internal/external storage media or cloud services.

10. A video recording system for a moving automotive vehicle comprising:
a camera system for recording front, rear, and lateral views from a moving vehicle, said lateral views including a passenger side view and a driver side view, and said camera forward said lateral view having adjustment along at least two axis;
a primary display system accessible to an operator of the vehicle including a heads-up display projected on a front windshield of said vehicle;
a primary camera control system accessible to the vehicle operator to modify views of the camera system, said primary camera control system including buttons positioned on a steering wheel of said vehicle;
a secondary display system accessible to a passenger of said vehicle, said secondary display system including a touchtone screen; and
a secondary control system accessible to a passenger of a vehicle to modify views of the camera system including functions controlled by said touchtone screen of said secondary display system.

11. A video recording system for a moving automotive vehicle as described in claim 10 wherein said secondary display system shows views of said camera system in real time and said videos can be stored by a method taken from a group of methods including internal/external media and/or cloud services.

12. A video recording system for a moving automotive vehicle as described in claim 10 further comprising a switch allowing for exclusive primary display system operation, exclusive secondary display system operation, and combined primary and secondary display system operation.

13. A video recording system for a moving automotive vehicle as described in claim 10 wherein said camera system has a feature taken from the group of features including timer shoot, photo burst, whole trip time lapse, customizable auto recording blast brief period, geotagging, social media compatibility, auto-tilt to adjust the aim of said camera when said vehicle is on non-level surfaces.

14. A video recording system for a moving automotive vehicle comprising:
a camera system for recording front, rear, and lateral views from a moving vehicle, said lateral views including a passenger side view and a driver side view, and said camera forward said lateral view having adjustment along at least two axis;
a primary display system accessible to an operator of the vehicle including a heads-up display projected on a front windshield of said vehicle;
a primary camera control system accessible to the vehicle operator to modify views of the camera system, said primary camera control system including buttons positioned on a steering wheel of said vehicle;
a secondary display system accessible to a passenger of said vehicle, said secondary display system including a touchtone screen;
a secondary control system accessible to a passenger of a vehicle to modify views of the camera system including functions controlled by said touchtone screen of said secondary display system; and
wherein said video recording system has a switch aligned for exclusive primary display system operation, exclusive secondary display system operation, and combine primary and secondary display operation.

15. A video recording system for a moving automotive vehicle as described in claim 14 wherein said switch also allows for independent camera system control and recording of the primary camera control system and the secondary camera control system.

16. A video recording system for a moving automotive vehicle as described in claim 14 wherein said camera system has a feature taken from the group of features including timer shoot, photo burst, whole trip time lapse, customizable auto recording blast brief period, geotagging, social media compatibility, auto-tilt to adjust the aim of said camera when said vehicle is on non-level surfaces.
